(19) United States
(12) Patent Application Publication
(10) Pub. No.: US 2025/0220155 A1
(43) Pub. Date: Jul. 3, 2025

(54) GEOMETRIC PARTITIONING MODE AND MERGE CANDIDATE REORDERING

(71) Applicant: MEDIATEK INC., Hsinchu City (TW)

(72) Inventors: Chih-Hsuan LO, Hsinchu City (TW); Chih-Yao CHIU, Hsinchu City (TW); Chun-Chia CHEN, Hsinchu City (TW); Tzu-Der CHUANG, Hsinchu City (TW); Chih-Wei HSU, Hsinchu City (TW); Ching-Yeh CHEN, Hsinchu City (TW); Yu-Wen HUANG, Hsinchu City (TW)

(21) Appl. No.: 18/847,479

(22) PCT Filed: Mar. 17, 2023
(86) PCT No.: PCT/CN2023/082290

§ 371 Date: Sep. 16, 2024

Related U.S. Application Data
(60) Provisional application No. 63/321,351, filed on Mar. 18, 2022.

(51) Int. Cl. H04N 19/103; H04N 19/119; H04N 19/157; H04N 19/176

(52) U.S. Cl. CPC H04N 19/103; H04N 19/119; H04N 19/157; H04N 19/176

(57) ABSTRACT

A video coder (encoder or decoder) receives data for a block of pixels to be encoded or decoded as a current block of a current picture of a video. The video coder classifies multiple partition modes into multiple groups of partition modes. Each partition mode segments the current block into at least two geometric partitions. The video coder signals or receives a selection of a group of partition modes from the multiple groups of partition modes. The video coder selects a partition mode from the selected group of partition modes. The video coder segments the current block into at least first and second partitions according to the selected partition mode. The video coder encodes or decodes the current block by combining a first prediction for the first partition and a second prediction for the second partition.

### CROSS REFERENCE TO RELATED PATENT APPLICATION(S)

The present disclosure is part of a non-provisional application that claims the priority benefit of U.S. Provisional Patent Application No. 63/321,351, filed on 18 Mar. 2022, respectively. Content of above-listed application is herein incorporated by reference.

### TECHNICAL FIELD

The present disclosure relates generally to video coding. In particular, the present disclosure relates to ordering of merge mode candidates and geometric partitioning mode.

### BACKGROUND

Unless otherwise indicated herein, approaches described in this section are not prior art to the claims listed below and are not admitted as prior art by inclusion in this section.

Versatile video coding (VVC) is the latest international video coding standard developed by the Joint Video Expert Team (JVET) of ITU-T SG16 WP3 and ISO/IEC JTCI/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one color component associated with CTU, CU, PU, and TU, respectively. Thus, a CTU consists of one luma CTB, two chroma CTBs, and associated syntax elements. A similar relationship is valid for CU, PU, and TU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for signaling partition modes and merge candidates for geometric partitioning mode (GPM). A video coder (encoder or decoder) receives data for a block of pixels to be encoded or decoded as a current block of a current picture of a video. The video coder classifies multiple partition modes into multiple groups of partition modes. Each partition mode is a geometric partitioning that segments the current block into at least two geometric partitions. The video coder signals or receives a selection of a group of partition modes from the multiple groups of partition modes. The video coder selects a partition mode from the selected group of partition modes. The video coder segments the current block into at least first and second partitions according to the selected partition mode. The video coder encodes or decodes the current block by combining a first prediction for the first partition and a second prediction for the second partition.

In some embodiments, the video coder computes a cost for encoding the current block for each partition mode of the plurality of partition modes, identifies a best partition mode from the plurality of partition modes based on the computed costs, and selects a group of partition modes that includes the identified best partition mode. The cost for encoding the current block for a partition mode may be a template matching cost or a boundary matching cost of using the partition mode to encode the current block. In some embodiments, the video coder identifies the best partition mode by identifying a lowest cost partition mode for each group of the plurality of groups of partition modes.

In some embodiments, the video coder computes a cost for encoding the current block for each partition mode in the selected group of partition modes. The video coder may select a partition mode from the selected group of partition modes by selecting a lowest cost partition mode from the selected group of partition modes. The video coder may select a partition mode from the selected group of partition modes by re-ordering the partition modes in the selected group according to the computed costs and signaling or receiving a selection of a partition mode based on the re-ordering.

In some embodiments, a video coder receives data for a block of pixels to be encoded or decoded as a current block of a current picture of a video. The video coder signals or receives a selection of a partition mode from a plurality of partition modes. Each partition mode is a geometric partitioning that segments the current block into at least two partitions. The video coder computes a cost for each merge candidate of each of the at least two partitions of the current block formed by the selected partition mode. The video coder selects a set of at least merge candidates for the at least two partitions formed by the selected partition mode based on the computed costs. The video coder encodes or decodes the current block by combining two predictions of the at least two partitions based on the selected set of at least two merge candidates.

In some embodiments, for each partition mode of the plurality of partition modes, the video coder computes a cost for each set of at least two merge candidates for the at least two partitions formed by the partition mode, identifies a set of at least two merge candidates for the at least two partitions based on the computed costs. The selected partition mode is selected based on the computed costs of the identified pairs of merge candidates of the plurality of partition modes. The video coder may select the set of at least two merge candidates based on the computed costs by re-ordering the merge candidates of the at least two partitions formed by the selected partition mode according to the computed costs and signaling or receiving a selection of a set of at least two merge candidates based on the re-ordering. The video coder may select the set of at least two merge candidates based on the computed costs by selecting a set of at least two merge candidates having a lowest cost among the merge candidates of the at least two partitions formed by the selected partition mode.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 illustrates the motion candidates of merge mode.

FIG. 2 conceptually illustrates an algorithm framework for merge candidates.

FIG. 3 conceptually illustrates an example candidate reordering.

FIGS. 4-5 conceptually illustrate the L-shape matching method for calculating the guess costs of selected candidates.

FIG. 6 illustrates neighboring samples and reconstructed samples that are used for determining boundary matching cost.

FIG. 7 illustrates the partitioning of a CU by the geometric partitioning mode (GPM).

FIG. 8 illustrates an example uni-prediction candidate list for a GPM partition and the selection of a uni-prediction MV.

FIG. 9 illustrates an example partition edge blending process for GPM for a coding unit.

FIG. 10 conceptually illustrates classifying GPM partition modes into partition mode groups and identifying a best partition mode group.

FIG. 11 conceptually illustrates identifying a GPM partition mode that results in the best merge candidates for the at least two GPM partitions.

FIG. 12 illustrates an example video encoder that may use GPM to encode pixel blocks.

FIG. 13 illustrates portions of the video encoder that implement GPM predictor signaling based on TM or BM costs.

FIG. 14 conceptually illustrates a process for signaling selection of GPM partition modes.

FIG. 15 illustrates an example video decoder that may implement GPM to decode and reconstruct pixel blocks.

FIG. 16 illustrates portions of the video decoder that implement GPM predictor signaling based on costs.

FIG. 17 conceptually illustrates a process for receiving selection of GPM partition modes.

FIG. 18 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### 1. Candidate Reordering for Merge Mode

FIG. 1 illustrates the motion candidates of merge mode. The figure shows a current block 100 of a video picture or frame being encoded or decoded by a video codec. As illustrated, up to four spatial MV candidates are derived from spatial neighbors A0, A1, B0 and B1, and one temporal MV candidate is derived from TBR or TCTR (TBR is used first, if TBR is not available, TCTR is used instead). If any of the four spatial MV candidates is not available, the position B2 is then used to derive MV candidate as a replacement. After the derivation process of the four spatial MV candidates and one temporal MV candidate, removing redundancy (pruning) is applied in some embodiments to remove redundant MV candidates. If after removing redundancy (pruning), the number of available MV candidates is smaller than five, three types of additional candidates are derived and are added to the candidate set (candidate list). A video encoder selects one final candidate within the candidate set for Skip, or Merge modes based on the rate-distortion optimization (RDO) decision and transmits the index to a video decoder. (Skip mode and merge mode are collectively referred to as “merge mode” in this document.)

For some embodiments, merge candidates are defined as the candidates of a general “prediction+merge” algorithm framework. The “prediction+merge algorithm framework has a first part and a second part. The first part generating a candidate list (a set) of predictors that are derived by inheriting neighboring information or refining or processing neighboring information. The second part is sending (i) a merge index to indicate which inheriting neighbor in the candidate list is selected and (ii) some side information related to the merge index. In other words, the encoder signals the merge index and some side information for the selected candidate to the decoder.

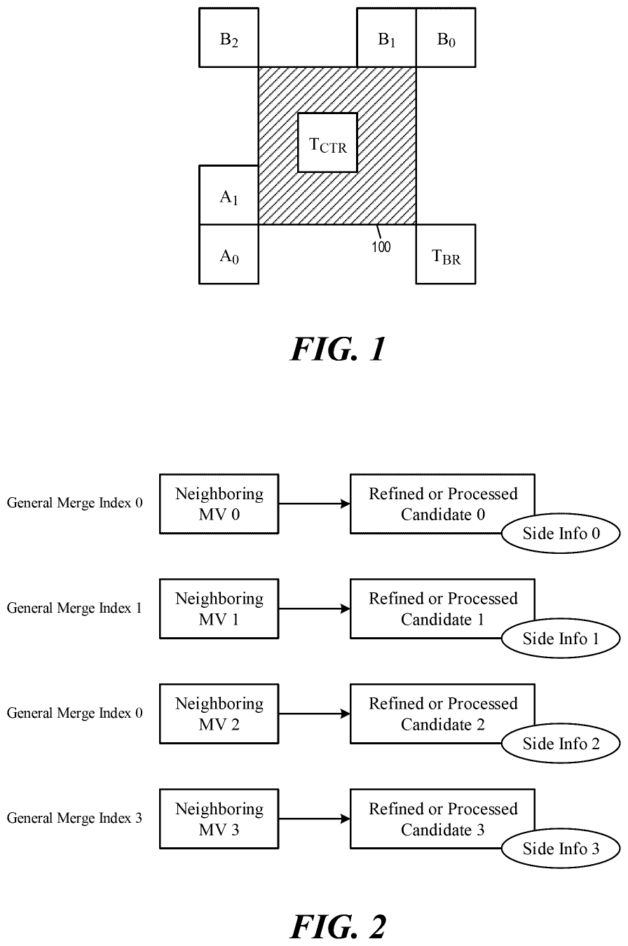

FIG. 2 conceptually illustrates the “prediction+merge” algorithm framework for merge candidates. The candidate list includes many candidates that inherit neighboring information. The inherited information is then processed or refined to form new candidates. During the processes, some side information for the candidates is generated and sent to decoder.

Video coders (encoders or decoders) may process merge candidates in different ways. Firstly, in some embodiments, a video coder may combine two or more candidates into one candidate. Secondly, in some embodiments, a video coder may use the original candidate to be the original MV predictor and perform motion estimation searching using the current block of pixels to find a final MVD (Motion Vector Difference), where the side information is the MVD. Thirdly, in some embodiments, a video coder may use the original candidate to be the original MV predictor and perform motion estimation searching using the current block of pixels to find a final MVD for L0, and the L1 predictor is the original candidate. Fourthly, in some embodiments, a video coder may use the original candidate to be the original MV predictor and perform motion estimation searching using current block pixels to find a final MVD for L1, and the L0 predictor is the original candidate. Fifthly, in some embodiments, a video coder may use the original candidate to be the original MV predictor and do MV refinement searching using top or left neighboring pixels as searching template to find a final predictor. Sixthly, a video coder may use the original candidate to be the original MV predictor and perform MV refinement searching using bi-lateral template (pixels on L0 and L1 reference pictures pointed by candidate MV or mirrored MV) as searching template to find a final predictor.

Template matching (TM) is a video coding method to refine a prediction of the current CU by matching a template (current template) of the current CU in the current picture and a reference template in a reference picture for the prediction. A template of a CU or block generally refers to a specific set of pixels neighboring the top and/or the left of the CU.

For this document, the term “merge candidate” or “candidate” means the candidate in the general “prediction+merge” algorithm framework. The “prediction+merge” algorithm framework is not restricted to the previous described embodiments. Any algorithm having “prediction+merge index” behavior all belongs to this framework.

In some embodiments, a video coder reorders the merge candidates, i.e., the video coder modifies the candidate order inside the candidate list to achieve better coding efficiency. The reorder rule depends on some pre-calculation for the current candidates (merge candidates before the reordering), such as upper neighbor condition (modes, MVs and so on) or left neighbor condition (modes, MVs and so on) of the current CU, the current CU shape, or up/left L-shape template matching.

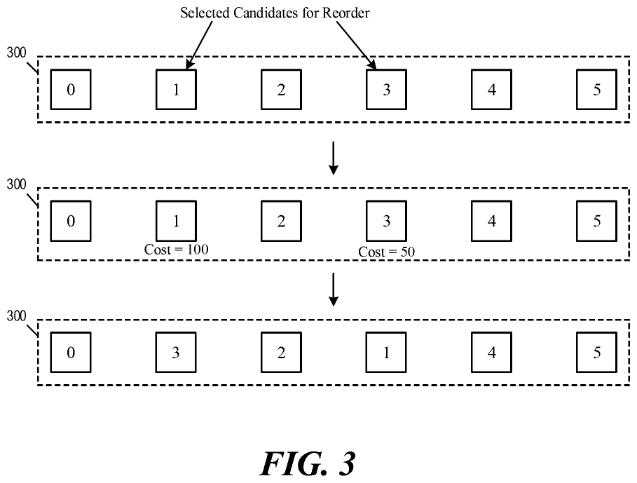

FIG. 3 conceptually illustrates an example candidate reordering. As illustrated, an example merge candidate list 300 has six candidates labeled ‘0’ through ‘5’. The video coder initially selects some candidates (candidates labeled ‘1’ and ‘3’) for reordering. The video coder then pre-calculates the cost of those candidates (100 and 50 for candidates labeled ‘1’ and ‘3’ respectively). The cost is named as the guess-cost of the candidate (since this is not the true cost of using the candidate and is only an estimate or guess of the true cost), the lower the cost means the better the candidate. Finally, the video coder reorders the selected candidates by moving lower cost candidates (the candidate labeled ‘3’) to the front of the list.

In general, for a merge candidate Ci having an order position Oi in the merge candidate list (with i=0˜N−1, N is total number of candidates in the list, Oi=0 means Ci is at the beginning of the list and Oi=N−1 means Ci is at the end of the list), with Oi=i (C0 order is 0, C1 order is 1, C2 order is 2 . . . and so on), the video coder reorders merge candidates in the list by changing the Oi for Ci for selected values of i (changing the order of some selected candidates).

In some embodiments, Merge Candidate Reordering can be turned off according to the size or shape of the current PU or CU. The video coder may pre-define several PU sizes or shapes for turning-off Merge Candidate Reordering. In some embodiments, other conditions are involved for turning off the Merge Candidate Reordering, such as picture size, QP value, and so on, being certain predefined values. In some embodiments, the video coder may signal a flag to switch on or off Merge Candidate Reordering. For example, a flag (e.g., “merge_cand_rdr_en”) may be signaled to indicate whether “Merge Candidate Reorder” is enabled (value 1: enabled, value 0: disabled). When not present, the value of merge_cand_rdr_en is inferred to be 1. The minimum sizes of units in the signaling, merge_cand_rdr_en, can also be separately coded in sequence level, picture level, slice level, or PU level.

Generally, a video coder may perform candidate reordering by (1) identifying one or more candidates for reordering, (2) calculating a guess-cost for each identified candidate, and (3) reordering the candidates according to the guess-costs of the selected candidates. In some embodiments, the calculated guess-costs of some of the candidates are adjusted (cost adjustment) before the candidates are reordered.

In some embodiments, a L-shape matching method is used for calculating the guess-costs of selected candidates. For a currently selected merge candidate, the video coder retrieves a L-shape template of current picture (current template) and a L-shape template of reference picture (reference template) and compares the difference between the at least two templates. The L-shape matching method has two parts or steps: (i) identifying the L-shape templates and (ii) matching the derived templates to determine the guess cost, or the matching cost of the candidate.

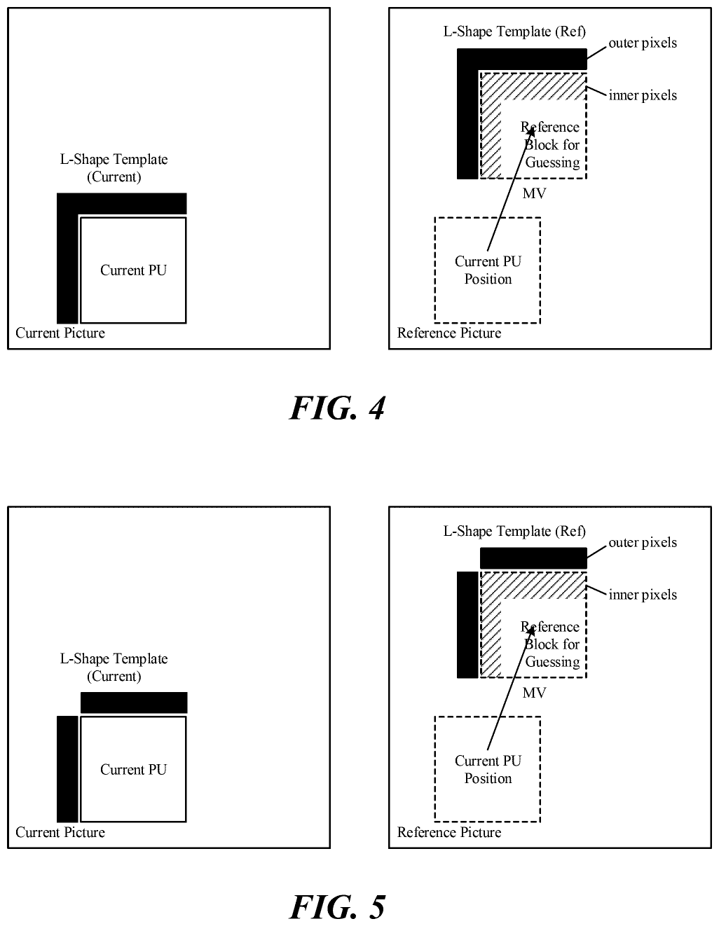

FIGS. 4-5 conceptually illustrate the L-shape matching method for calculating the guess costs of selected candidates. FIG. 4 shows a L-shape template of the current CU (current template) in the current picture that includes some pixels around top and left boundaries of the current PU or CU. The L-shape template of reference picture includes some pixels around top and left boundaries of “reference block for guessing” for current merge candidate. The “reference block for guessing” (with width BW and height BH same as current PU) is the block pointed by integer part of the motion vector of the current merge candidate.

Different embodiments define the L-shape template differently. In some embodiments, all pixels of L-shape template are outside the “reference block for guessing” (as “outer pixels” label in FIG. 4). In some embodiments, all pixels of L-shape template are inside the “reference block for guessing” (as “inner pixels” label in FIG. 4). In some embodiments, some pixels of L-shape template are outside the “reference block for guessing” and some pixels of L-shape template are inside the “reference block for guessing”. FIG. 5 shows a L-shape template of the current PU or CU (current template) in the current picture that is similar to that of FIG. 4 but has no left-top corner pixels, and the L-shape template in the reference picture (of outer pixel embodiment) has no left-top corner pixels.

In some embodiments, the L-shaped matching method and the corresponding L-shape template (named template_std) is defined according to the following: assuming the width of current PU is BW, and height of current PU is BH, the L-shape template of current picture has a top part and a left part. Defining top thick=TTH, left thick=LTH, then, the top part includes all current picture pixels of coordinate (ltx+tj, lty−ti), in which ltx is the Left-top integer pixel horizontal coordinate of the current PU, lty is the Left-top integer pixel vertical coordinate of the current PU, ti is an index for pixel lines (ti is 0˜(TTH−1)), tj is a pixel index in a line (tj is 0˜BW−1). For the left part, it includes all current picture pixels of coordinate (ltx−tjl, lty+til), in which ltx is the Left-top integer pixel horizontal coordinate of the current PU, lty is the Left-top integer pixel vertical coordinate of the current PU, til is a pixel index in a column (til is 0˜(BH−1)), tjl is an index of columns (tjl is 0˜(LTH−1)).

In template_std, the L-shape template of reference picture has a top part and a left part. Defining top thickness=TTHR, left thickness=LTHR, then, top part includes all reference picture pixels of coordinate (ltxr+tjr, ltyr−tir+shifty), in which ltxr is the Left-top integer pixel horizontal coordinate of the reference_block_for_guessing, ltyr is the Left-top integer pixel vertical coordinate of the reference_block_for_guessing, tir is an index for pixel lines (tir is 0˜(TTHR−1)), tjr is a pixel index in a line (tjr is 0˜BW−1), shifty is a pre-define shift value. For the left part, it consists of all reference picture pixels of coordinate (ltxr−tjlr+shiftx, ltyr+tilr), in which ltxr is the Left-top integer pixel horizontal coordinate of the reference_block_for_guessing, ltyr is the Left-top integer pixel vertical coordinate of the reference_block_for_guessing, tilr is a pixel index in a column (tilr is 0˜(BH−1)), tjlr is an index of columns (tjlr is 0˜(LTHR−1)), shiftx is a pre-define shift value.

There is one L-shape template for reference picture if the current candidate only has L0 MV or only has L1 MV. But there are 2 L-shape templates for the reference picture if the current candidate has both L0 and L1 MVs (bi-prediction candidate), one template is pointed to by the L0 MV in the L0 reference picture, the other template is pointed to by L1 MV in the L1 reference picture.

In some embodiments, for the L-shape template, the video coder has an adaptive thickness mode. The thickness is defined as the number of pixel rows for the top part in L-shape template or the number of pixel columns for the left part in L-shape template. For the previously mentioned L-shape template template_std, the top thickness is TTH and left thickness is LTH in the L-shape template of current picture, and the top thickness is TTHR and left thickness is LTHR in the L-shape template of reference picture. The adaptive thickness mode changes the top thickness or left thickness depending on some conditions, such as the current PU size or the current PU shape (width or height) or the QP of current slice. For example, the adaptive thickness mode can let top thickness=2 if current PU height ≥32, and top thickness=1 if current PU height<32.

When performing L-shape template matching, the video coder retrieves the L-shape template of current picture and L-shape template of reference picture and compares (matches) the difference between the at least two templates. The difference (e.g., Sum of Absolute Difference, or SAD) between the pixels in the at least two templates is used as the matching cost of the MV. In some embodiments, the video coder may obtain the selected pixels from the L-shape template of the current picture and the selected pixels from the L-shape template of reference picture before computing the difference between the selected pixels of the at least two L-shape templates.

In some embodiments, the cost of using a coding tool or prediction mode to code the current block, e.g., a particular pair of (or a set of at least two) merge candidates for a partitioning mode, can be evaluated by boundary matching cost. Boundary matching (BM) cost is a similarity (or discontinuity) measure that quantifies the correlation between the reconstructed pixels of the current block and the (reconstructed) neighboring pixels along the boundaries of the current block. The boundary matching cost based on pixel samples that are reconstructed according to a particular coding tool or prediction mode is used as the boundary matching cost of that particular coding tool or prediction mode.

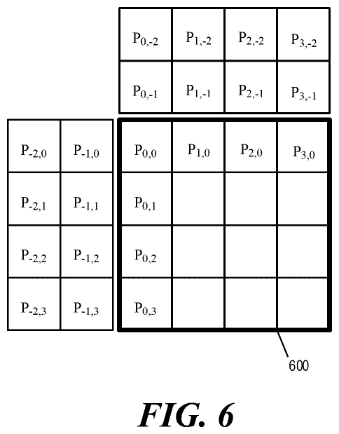

FIG. 6 illustrates the neighboring samples and the reconstructed samples of a 4×4 block that are used for determining boundary matching cost. In the figure, p_{x,-2}, p_{x,-1} are reconstructed neighboring samples above a current block 600, p_{-2,y}, p_{-1,y} are reconstructed neighboring samples left of the current block, p_{x,0}, p_{0,y} are samples of the current block 600 along the top and left boundaries that are reconstructed according to a particular transform configuration.

For one 4×4 block, the cost can be calculated by using the pixels across the top and left boundaries by the following equation that provide a similarity measure (or discontinuity measure) at the top and left boundaries for the hypothesis:

$$cost = {\sum }_{x = 0}^{w - 1} \vert - {p}_{x , - 2} + 2 {p}_{x , - 1} - {p}_{x , 0} \vert + {\sum }_{y = 0}^{h - 1} \vert - {p}_{- 2 , y} + 2 {p}_{- 1 , y} - {p}_{0 , y} \vert \qquad ( 1 )$$

The cost obtained by using Eqn. (1) can be referred to as the boundary matching (BM) cost. In some embodiments, when performing the boundary matching process, only the border pixels are reconstructed, unnecessary operations such as inverse secondary transform can be avoided for complexity reduction.

### II. Geometric Partitioning Mode (GPM)

In VVC, a geometric partitioning mode is supported for inter prediction. The geometric partitioning mode (GPM) is signalled using a CU-level flag as one kind of merge mode, with other merge modes that includes the regular merge mode, the MMVD mode, the CIIP mode, and the subblock merge mode. In total 64 partition modes are supported by geometric partitioning mode for each possible CU size w×h=2^{m}×2ⁿ with m, n∈{3 . . . 6} excluding 8×64 and 64×8.

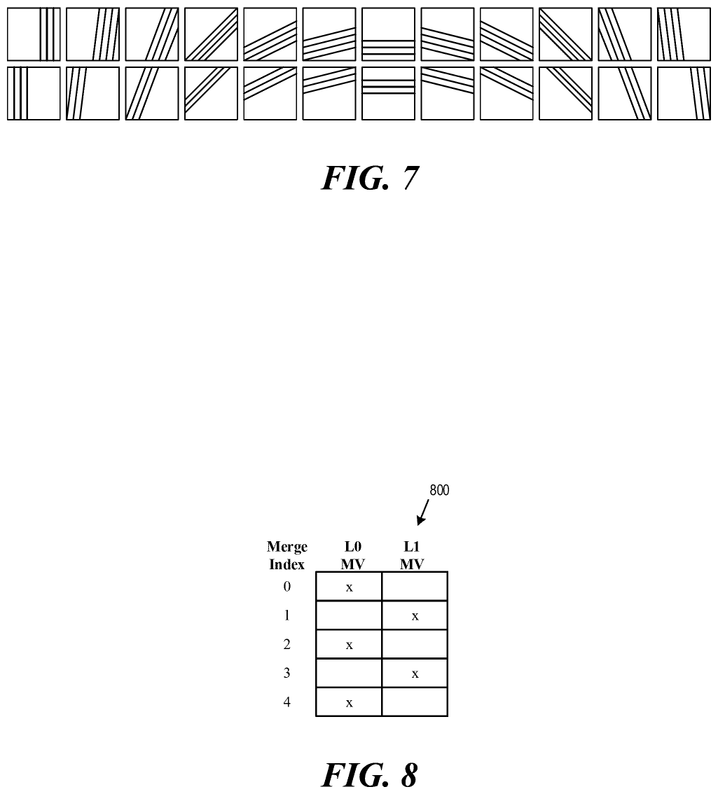

FIG. 7 illustrates the partitioning of a CU by the geometric partitioning mode (GPM). Each GPM partitioning or GPM split is a partition mode characterized by a distance-angle pairing that defines a bisecting or segmenting line. The figure illustrates examples of the GPM splits grouped by identical angles. As illustrated, when GPM is used, a CU is split into at least two parts by a geometrically located straight line. The location of the splitting line is mathematically derived from the angle and offset parameters of a specific partition.

Each partition in the CU formed by a partition mode of GPM is inter-predicted using its own motion (vector). In some embodiments, only uni-prediction is allowed for each partition, that is, each part has one motion vector and one reference index. The uni-prediction motion constraint is applied to ensure that, similar to conventional bi-prediction, only two motion compensated prediction are performed for each CU.

If GPM is used for the current CU, then a geometric partition index indicating the partition mode of the geometric partitioning (angle and offset) and two merge indices (one for each partition) are further signalled. Each of the at least two partitions created by the geometric partitioning according to a partition mode may be assigned a merge index to select a candidate from a uni-prediction candidate list (also referred to as the GPM candidate list). The pair of merge indices of the two partitions therefore select a pair of merge candidates. The maximum number of candidates in the GPM candidate list may be signalled explicitly in SPS to specify syntax binarization for GPM merge indices. After predicting each of the at least two partitions, the sample values along the geometric partitioning edge are adjusted using a blending processing with adaptive weights. This is the prediction signal for the whole CU, and transform and quantization process will be applied to the whole CU as in other prediction modes. The motion field of the CU as predicted by GPM is then stored.

The uni-prediction candidate list for a GPM partition (the GPM candidate list) may be derived directly from the merge candidate list of the current CU. FIG. 8 illustrates an example uni-prediction candidate list 800 for a GPM partition and the selection of a uni-prediction MV for GPM. The GPM candidate list 800 is constructed in an even-odd manner with only uni-prediction candidates that alternates between L0 MV and L1 MV. Let n be the index of the uni-prediction motion in the uni-prediction candidate list for GPM. The LX (i.e., L0 or L1) motion vector of the n-th extended merge candidate, with X equal to the parity of n, is used as the n-th uni-prediction motion vector for GPM. (These motion vectors are marked with “x” in the figure.) In case a corresponding LX motion vector of the n-th extended merge candidate does not exist, the L(1-X) motion vector of the same candidate is used instead as the uni-prediction motion vector for GPM.

As mentioned, the sample values along the geometric partition edge are adjusted using a blending processing with adaptive weights. Specifically, after predicting each part of a geometric partition using its own motion, blending is applied to the at least two prediction signals to derive samples around geometric partition edge. The blending weight for each position of the CU are derived based on the distance between the individual position and the partition edge. The distance for a position (x, y) to the partition edge are derived as:

$$d ( x , y ) = ( 2 x + 1 − w ) cos ( {φ}_{i} ) + ( 2 y + 1 − h ) sin ( {φ}_{i} ) − {ρ}_{j} \qquad ( 2 )$$

$$\begin{matrix} & {ρ}_{j} = {ρ}_{x , j} cos ( {φ}_{i} ) + {ρ}_{y , j} sin ( {φ}_{i} )\end{matrix} \qquad ( 3 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 4 )$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 5 )$$

where i, j are the indices for angle and offset of a geometric partition, which depend on the signaled geometric partition index. The sign of ρ_{x,j} and ρ_{y,j} depend on angle index i. The weights for each part of a geometric partition are derived as following:

$$wIdxL ( x , y ) = partIdx ? 32 + d ( x , y ) : 32 - d ( x , y ) \qquad ( 6 )$$

$${w}_{0} ( x , y ) = \frac{Clip 3 ( 0 , 8 , ( widxL ( x , y ) + 4 ) ≫ 3 )}{8} \qquad ( 7 )$$

$${w}_{1} ( x , y ) = 1 - {w}_{0} ( x , y ) \qquad ( 8 )$$

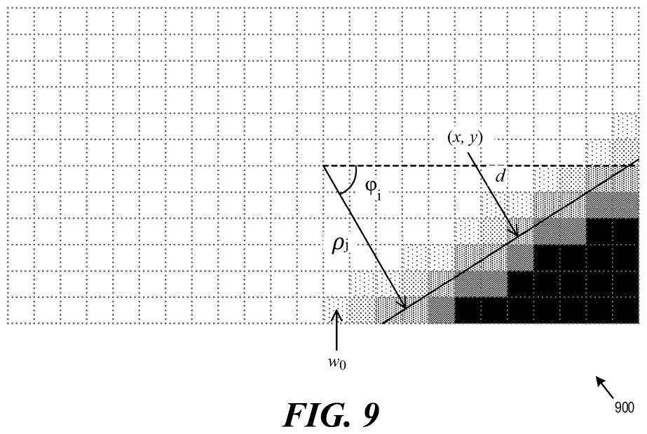

The variable partIdx depends on the angle index i. FIG. 9 illustrates an example partition edge blending process for GPM for a CU 900. In the figure, blending weights are generated based on an initial blending weight w₀.

As mentioned, the motion field of a CU predicted using GPM is stored. Specifically, Mv1 from the first part of the geometric partition, Mv2 from the second part of the geometric partition and a combined Mv of Mv1 and Mv2 are stored in the motion field of the GPM coded CU. The stored motion vector type for each individual position in the motion filed are determined as:

$$sType = abs ( motionIdx ) < 32 ? \qquad ( 9 )$$

$$2 : ( motionIdx \leq 0 ? ( 1 - partIdx ) : partIdx )$$

where motionIdx is equal to d (4x+2, 4y+2), which is recalculated from equation (2). The partIdx depends on the angle index i. If sType is equal to 0 or 1, Mv0 or Mv1 are stored in the corresponding motion field, otherwise if sType is equal to 2, a combined Mv from Mv0 and Mv2 are stored. The combined Mv are generated using the following process: (i) If Mv1 and Mv2 are from different reference picture lists (one from L0 and the other from L1), then Mv1 and Mv2 are simply combined to form the bi-prediction motion vectors; (ii) otherwise, if Mv1 and Mv2 are from the same list, only uni-prediction motion Mv2 is stored.

### III. Signaling GPM Predictor

A GPM predictor is defined based on two merge candidates and a GPM partition mode. To indicate which merge candidates and which GPM partition mode are selected for a GPM predictor, a video encoder signals, and a video decoder receives, two merge indices and a GPM partition index. However, the signaling of the merge indices (which are coded by variable-length coding) and the partition index (which is coded by fix-length coding) leads to syntax overhead. In order to reduce the signaling overhead and to improve coding efficiency, some embodiments of the disclosure provide methods of signaling the GPM partition mode and the merge candidates that reduces signaling overhead.

In some embodiments, the video coder classifies all GPM partition modes into partition mode groups and applies a mode reordering/selection method to determine or identify the best partition modes in each group (denoted as partition_cands). By sorting partition_cands based on the RDO costs in ascending order, the best partition mode for GPM is determined and the partition mode group containing the best partition mode is inferred to be the best partition mode group. Instead of signaling a partition index, a group index with reduced bit length (i.e., the bit length of group index is less than partition index) is signaled for decoder to notify which GPM partition mode group is selected. At decoder side, a mode reordering/selection method may be performed in the selected partition mode group to identify the best partition mode.

In some embodiments, the 64 GPM partition modes are classified into different partition mode groups (e.g., mode indices can be classified into four groups as 4n, 4n+1, 4n+2, 4n+3. Or more generally, mode indices can be classified into M groups as Mn, Mn+1, Mn+2, . . . . Mn+ (M−1). For each group, some similar modes (i.e., modes with similar partition directions) or diverse modes (i.e., modes with different partition directions) are collected or identified. Within each group, a cost is computed (by computing e.g., template matching costs or boundary matching cost) for each GPM partition mode by blending the reference templates of the at least two partitions of the partition mode (according to respective weights of the at least two partitions, as described by reference to FIG. 9 above.) The best GPM partition mode is then identified based on the computed costs of the modes in the group (e.g., the partition mode with the smallest cost is identified as the best GPM partition mode). By collecting the best partition mode(s) from each group, partition_cands is constructed. And then partition_cands is sorted by RDO costs in ascending order to identify the best partition mode and the best partition mode group for GPM. A group index with reduced bit length is signaled for decoder to indicate which GPM partition mode group is selected. At the decoder side, the video decoder computes template matching costs or the boundary matching costs for all GPM partition modes in the selected partition mode group, and the best partition mode with the smallest cost (template matching or boundary matching) is determined.

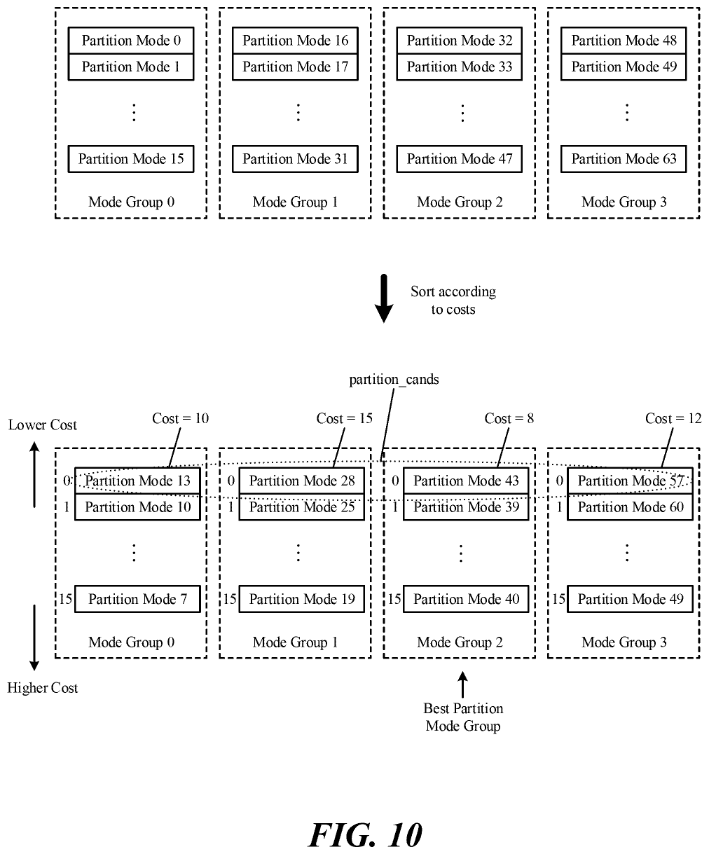

FIG. 10 conceptually illustrates classifying GPM partition modes into partition mode groups and identifying a best partition mode group. As illustrated, there 64 different GPM partition modes (partition modes 0 through 63) for partitioning the current block. The 64 partition modes are classified or assigned into four partition mode groups (mode groups 0 through 3). The partition modes of each group are sorted or reordered according to cost (by template matching or boundary matching). The best (e.g., lowest cost) partition mode of each group is identified. The identified best partition modes of the four groups are referred to as the partition_cands (which include partition modes 13, 28, 43, 57). In this example, partition mode 43 belonging to mode group 2 has the lowest cost among the partition_cands. Mode group 2 is therefore identified as the best partition mode group. A group index indicating partition mode group 2 may be signaled to the decoder.

At the decoder side, the video decoder may compute template matching costs or the boundary matching costs for all GPM partition modes in the selected partition mode group (group 2). In some embodiments, the lowest cost partition mode in the selected mode group is implicitly selected by the decoder. In some embodiments, the partition modes of the selected mode group are sorted or reordered according to the computed costs, and a partition mode selection index having reduced number of bits may be signaled by the encoder to select a partition mode based on the reordering.

In some embodiments, a certain GPM merge candidate reordering method or scheme is applied to identify the GPM partition mode that result in the best merge candidates for the at least two GPM partitions. First, the merge candidate reordering method is applied to merge candidate lists of different partition modes (denoted as mrg_cands). By sorting the mrg_cands of different partition modes based on their corresponding RDO costs in ascending order, the best merge candidate pair (with minimum cost) are identified and the corresponding partition mode (the one resulting in the best merge candidate pair) is inferred to be the best partition mode. Thus, instead of signaling a GPM partition mode index and two merge indices (as a GPM predictor), only one partition index is signaled to the decoder for indicating which GPM partition mode is selected. At the decoder side, a corresponding merge candidate reordering method is performed on all GPM merge candidates (of the selected GPM partition mode) to determine the best merge candidate pair along with the selected partition mode.

In some embodiments, for GPM merge candidate reordering, template matching costs or boundary matching costs are computed for each merge candidate pairs or for each merge candidate (of each partition) respectively to determine the best merge candidate pairs for each GPM partition mode (denoted as mrg_cands). By sorting mrg_cands with the RDO costs in ascending order, the best merge candidate pair of the two GPM partitions and the partition mode are determined. A partition mode index is signaled for decoder to notify which GPM partition mode is selected. At the decoder side, template matching costs or boundary matching costs are computed for each merge candidate pairs or for each merge candidates respectively of the selected partition mode. The best merge candidate pair with the minimum template matching cost is identified. In some embodiments, when the partition mode group is signaled, the decoder computes template or boundary matching costs for only the partition modes of the signaled mode group.

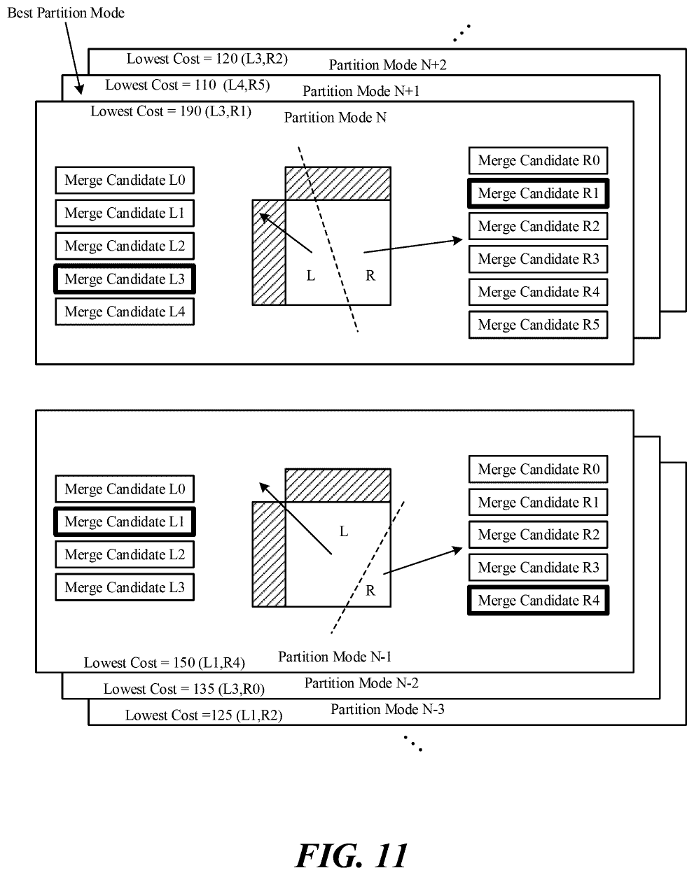

FIG. 11 conceptually illustrates identifying a GPM partition mode that results in the best merge candidates for the at least two GPM partitions. The figure illustrates various partition modes of the current block for GPM and their corresponding merge candidates. Each partition mode partition the current block into partition-L (left) and partition-R (right). The merge candidates (merge candidate list) of partition-L are labeled as merge candidates L0, L1, etc. The merge candidates of partition-R are labeled as merge candidates R0, R1, etc. For each partition mode, (template matching or boundary matching) costs for the merge candidates of partition-L and partition-R are computed. The best merge candidate for partition-L and the best merge candidate for partition-R are identified for each partition mode based on cost. For example, for template matching, the cost of a merge pair is computed by blending the templates of the partition-L merge candidate and the templates of the partition-R candidate. The blended template is then compared with the template of the current block (top and left neighbors). The best merge candidate pair for each partition mode are identified according to the computed costs. In the example illustrated, the best merge pair for partition mode N−1 is (L3, R1) with cost 150 and best merge pair for partition mode N is (L1, R4) with cost 190.

The best merge candidate pairs of the different partition modes are then compared based on the cost. Out of the 64 GPM partition modes, the partition mode having a best merge candidates pair that is better than the best merge candidates pair of all other partition modes is identified as the best partition mode and signaled to the decoder. In this example, the partition mode N+1 is identified as the best partition mode because its best merge candidate pair (L4, R5) has the lowest cost (110) among all partition modes. The index of partition mode N+1 can be signaled to decoder to select the partition mode.

At the decoder side, the video decoder computes template matching costs or the boundary matching costs for all merge candidate pairs of the selected partition mode (mode N+1). In some embodiments, the lowest cost merge pair of the selected partition mode is implicitly selected by the decoder. In some embodiments, the merge candidates are sorted or reordered for the selected partition mode according to the computed costs, and a merge candidate selection index having reduced number of bits may be signaled to select a merge candidate pair based on the reordering.

The foregoing proposed methods can be implemented in encoders and decoders. For example, any of the proposed methods can be implemented in a GPM coding module of an encoder, a GPM candidate and/or partition mode derivation module of a decoder. Alternatively, any of the proposed methods can be implemented as a circuit coupled to the GPM coding module of an encoder and a GPM candidate and/or partition mode derivation module of the decoder.

### III. Example Video Encoder

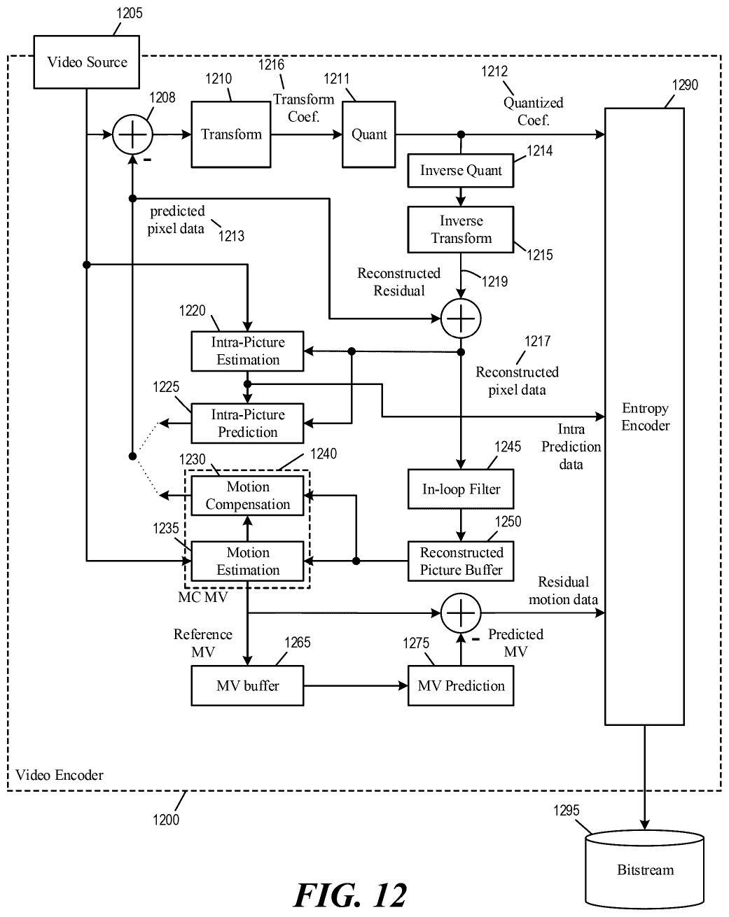

FIG. 12 illustrates an example video encoder 1200 that may use GPM to encode pixel blocks. As illustrated, the video encoder 1200 receives input video signal from a video source 1205 and encodes the signal into bitstream 1295. The video encoder 1200 has several components or modules for encoding the signal from the video source 1205, at least including some components selected from a transform module 1210, a quantization module 1211, an inverse quantization module 1214, an inverse transform module 1215, an intra-picture estimation module 1220, an intra-prediction module 1225, a motion compensation module 1230, a motion estimation module 1235, an in-loop filter 1245, a reconstructed picture buffer 1250, a MV buffer 1265, and a MV prediction module 1275, and an entropy encoder 1290. The motion compensation module 1230 and the motion estimation module 1235 are part of an inter-prediction module 1240.

In some embodiments, the modules 1210-1290 are modules of software instructions being executed by one or more processing units (e.g., a processor) of a computing device or electronic apparatus. In some embodiments, the modules 1210-1290 are modules of hardware circuits implemented by one or more integrated circuits (ICs) of an electronic apparatus. Though the modules 1210-1290 are illustrated as being separate modules, some of the modules can be combined into a single module.

The video source 1205 provides a raw video signal that presents pixel data of each video frame without compression. A subtractor 1208 computes the difference between the raw video pixel data of the video source 1205 and the predicted pixel data 1213 from the motion compensation module 1230 or intra-prediction module 1225. The transform module 1210 converts the difference (or the residual pixel data or residual signal 1208) into transform coefficients (e.g., by performing Discrete Cosine Transform, or DCT). The quantization module 1211 quantizes the transform coefficients into quantized data (or quantized coefficients) 1212, which is encoded into the bitstream 1295 by the entropy encoder 1290.

The inverse quantization module 1214 de-quantizes the quantized data (or quantized coefficients) 1212 to obtain transform coefficients, and the inverse transform module 1215 performs inverse transform on the transform coefficients to produce reconstructed residual 1219. The reconstructed residual 1219 is added with the predicted pixel data 1213 to produce reconstructed pixel data 1217. In some embodiments, the reconstructed pixel data 1217 is temporarily stored in a line buffer (not illustrated) for intra-picture prediction and spatial MV prediction. The reconstructed pixels are filtered by the in-loop filter 1245 and stored in the reconstructed picture buffer 1250. In some embodiments, the reconstructed picture buffer 1250 is a storage external to the video encoder 1200. In some embodiments, the reconstructed picture buffer 1250 is a storage internal to the video encoder 1200.

The intra-picture estimation module 1220 performs intra-prediction based on the reconstructed pixel data 1217 to produce intra prediction data. The intra-prediction data is provided to the entropy encoder 1290 to be encoded into bitstream 1295. The intra-prediction data is also used by the intra-prediction module 1225 to produce the predicted pixel data 1213.

The motion estimation module 1235 performs inter-prediction by producing MVs to reference pixel data of previously decoded frames stored in the reconstructed picture buffer 1250. These MVs are provided to the motion compensation module 1230 to produce predicted pixel data.

Instead of encoding the complete actual MVs in the bitstream, the video encoder 1200 uses MV prediction to generate predicted MVs, and the difference between the MVs used for motion compensation and the predicted MVs is encoded as residual motion data and stored in the bitstream 1295.

The MV prediction module 1275 generates the predicted MVs based on reference MVs that were generated for encoding previously video frames, i.e., the motion compensation MVs that were used to perform motion compensation. The MV prediction module 1275 retrieves reference MVs from previous video frames from the MV buffer 1265. The video encoder 1200 stores the MVs generated for the current video frame in the MV buffer 1265 as reference MVs for generating predicted MVs.

The MV prediction module 1275 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1295 by the entropy encoder 1290.

The entropy encoder 1290 encodes various parameters and data into the bitstream 1295 by using entropy-coding techniques such as context-adaptive binary arithmetic coding (CABAC) or Huffman encoding. The entropy encoder 1290 encodes various header elements, flags, along with the quantized transform coefficients 1212, and the residual motion data as syntax elements into the bitstream 1295. The bitstream 1295 is in turn stored in a storage device or transmitted to a decoder over a communications medium such as a network.

The in-loop filter 1245 performs filtering or smoothing operations on the reconstructed pixel data 1217 to reduce the artifacts of coding, particularly at boundaries of pixel blocks. In some embodiments, the filtering operation performed includes sample adaptive offset (SAO). In some embodiment, the filtering operations include adaptive loop filter (ALF).

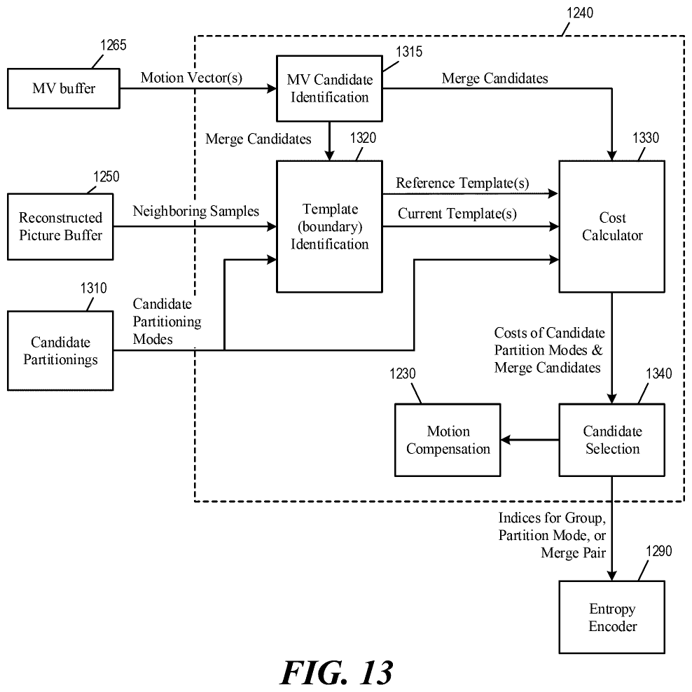

FIG. 13 illustrates portions of the video encoder 1200 that implement GPM predictor (partition mode+merge candidate pair) signaling based on TM or BM costs. Specifically, the figure illustrates the components of the inter-prediction module 1240 of the video encoder 1200. A candidate partitioning module 1310 provide candidate partition modes indicators to the inter-prediction module 1240. These possible candidate partition modes may correspond to various angle-distance pairings that defines a line that segments the current block into at least two (or more) partitions according to GPM. A MV candidate identification module 1315 identifies MV candidates (as merge candidates) that can be used for GPM partitions. The MV candidate identification module 1315 may identify only uni-prediction candidates or reuse merge candidates from the MV buffer 1265.

For each merge candidates and/or for each candidate partition modes, a template or boundary identification module 1320 retrieves neighboring samples from the reconstructed picture buffer 1250 as L-shaped templates, or generates predicted samples along the boundary of the current block. For a candidate partition mode that partitions the current block into at least two partitions, the template identification module 1320 may retrieve neighboring pixels of the current block as two current templates and use two motion vectors to retrieve two L-shaped pixel sets as two reference templates for the at least two partitions of the current block.

The template identification module 1320 provides the reference template(s), the current template(s), and/or boundary prediction samples of the currently indicated coding mode to a cost calculator 1330, which performs template or boundary matching to produce a cost for the indicated candidate partition mode. The cost calculator 1330 may combine the reference templates (with edge blending) according to GPM mode. The cost calculator 1330 may also compute template or boundary matching costs for different merge candidate pairs of different candidate partition modes. The cost calculator 1340 may also assign reordered indices based on the computed costs to partition mode groups, partition modes within a group, and/or merge candidates of a partition formed by a partition mode. TM or BM cost-based indices reordering is described in Section I above.

The computed costs of the various candidates are provided to a candidate selection module 1340, which may use the computed TM or BM costs to select a lowest cost candidate partition mode and/or merge candidate pair for encoding the current block. The selected candidate partition mode and/or merge candidate pair is indicated to the motion compensation module 1230 to complete prediction for encoding the current block. The selected partition mode or merge candidate is also provided to the entropy encoder 1290 to be signaled in the bitstream 1295. The selected partition mode and/or merge candidate pair may be signaled by using the partition mode's or the merge candidates' corresponding reordered index to reduce the number of bits transmitted. In some embodiments, the candidate partition modes are classified into groups, and an index indicating the group that includes the selected candidate partition mode is provided to the entropy encoder 1290 to be signaled in the bitstream. In some embodiments, the partition mode and/or the merge candidate pair may be signaled implicitly (i.e., not in the bitstream) based on computed costs at the decoder.

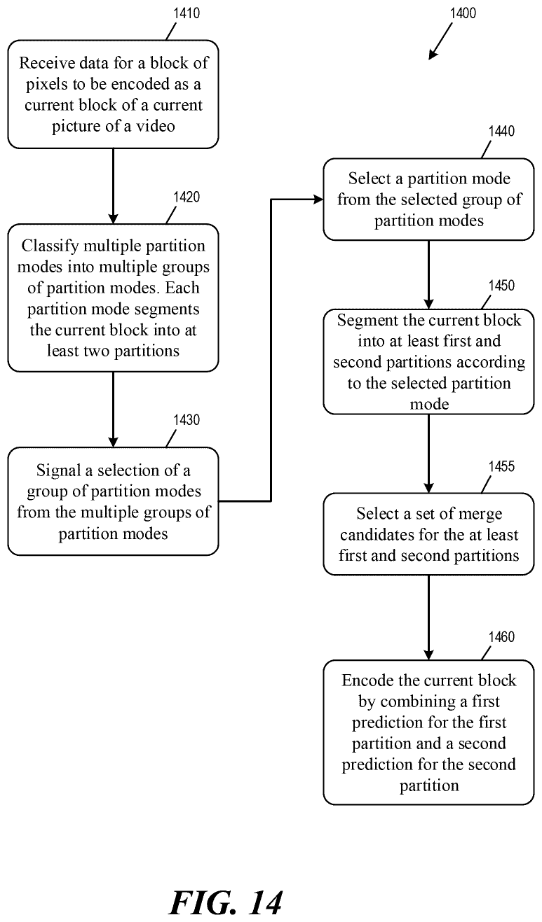

FIG. 14 conceptually illustrates a process 1400 for signaling selection of GPM partition modes. In some embodiments, one or more processing units (e.g., a processor) of a computing device implementing the encoder 1200 performs the process 1400 by executing instructions stored in a computer readable medium. In some embodiments, an electronic apparatus implementing the encoder 1200 performs the process 1400.

The encoder receives (at block 1410) data to be encoded as a current block of pixels in a current picture. The encoder classifies (at block 1420) a plurality of partition modes into a plurality of groups of partition modes. Each partition mode may be a GPM partition mode that segments the current block into at least two partitions.

The encoder signals (at block 1430) a selection of a group of partition modes from the plurality of groups of partition modes. This selection is based on the encoder computing a cost for encoding the current block for each partition mode of the plurality of partition modes, identifying a best partition mode from the plurality of partition modes based on the computed costs, and selecting a group of partition modes that includes the identified best partition mode. The encoder may identify the best partition mode by identifying a lowest cost partition mode for each group of the plurality of groups of partition modes. The cost for encoding the current block for a partition mode may be a template matching cost or a boundary matching cost of using the partition mode to encode the current block.

The encoder selects (at block 1440) a partition mode from the selected group of partition modes. The encoder may select the partition mode from the selected group by computing a cost for encoding the current block for each partition mode in the selected group of partition modes, then select a lowest cost partition mode from the selected group of partition modes. The encoder may also re-order the partition modes in the selected group according to the computed costs and signaling the selection of a partition mode based on the re-ordering.

The encoder segments (at block 1450) the current block into at least first and second partitions according to the selected partition mode.

The encoder selects (at block 1455) a set of at least two merge candidates for the first and second partitions. The merge candidate pair is used to generate a first prediction for the first partition and the second prediction for the second partition.

In some embodiments, the encoder selects the set of at least two merge candidates by computing a cost for each merge candidate of each of first and second partitions of the current block formed by the selected partition mode and selecting a set of at least two merge candidates for the first and second partitions based on the computed costs. The cost for a set of at least two merge candidates may be a template matching cost or a boundary matching cost of using the set of at least two merge candidates and the partition mode to encode the current block.

In some embodiments, for each partition mode of the plurality of partition modes, the encoder computes a cost for each set of at least two merge candidates for the at least two partitions and identifies a best set of at least two merge candidates based on the computed costs of the set of at least two merge candidates. The selected partition mode has the lowest cost merge pair among the best pairs of merge candidates of the different partition modes.

The encoder encodes (at block 1460) the current block by combining a first prediction for the first partition and a second prediction for the second partition. The first and second predictions may be based on the selected set of at least two merge candidates. The first and second predictions are used to produce prediction residuals and to reconstruct the current block.

### IV. Example Video Decoder

In some embodiments, an encoder may signal (or generate) one or more syntax element in a bitstream, such that a decoder may parse said one or more syntax element from the bitstream.

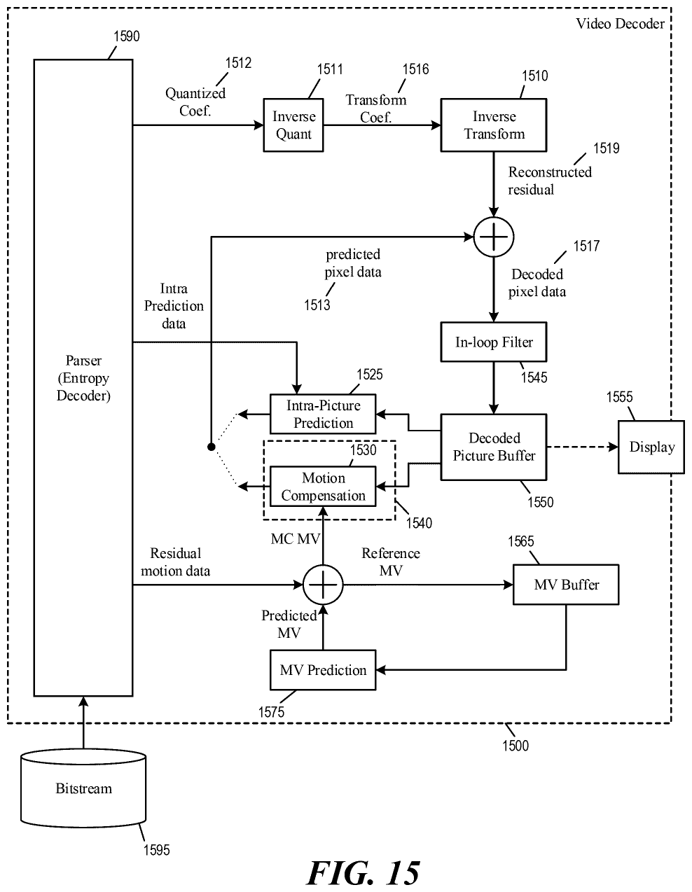

FIG. 15 illustrates an example video decoder 1500 that may implement GPM to decode and reconstruct pixel blocks. As illustrated, the video decoder 1500 is an image-decoding or video-decoding circuit that receives a bitstream 1595 and decodes the content of the bitstream into pixel data of video frames for display. The video decoder 1500 has several components or modules for decoding the bitstream 1595, including some components selected from an inverse quantization module 1511, an inverse transform module 1510, an intra-prediction module 1525, a motion compensation module 1530, an in-loop filter 1545, a decoded picture buffer 1550, a MV buffer 1565, a MV prediction module 1575, and a parser 1590. The motion compensation module 1530 is part of an inter-prediction module 1540.

In some embodiments, the modules 1510-1590 are modules of software instructions being executed by one or more processing units (e.g., a processor) of a computing device. In some embodiments, the modules 1510-1590 are modules of hardware circuits implemented by one or more ICs of an electronic apparatus. Though the modules 1510-1590 are illustrated as being separate modules, some of the modules can be combined into a single module.

The parser 1590 (or entropy decoder) receives the bitstream 1595 and performs initial parsing according to the syntax defined by a video-coding or image-coding standard. The parsed syntax element includes various header elements, flags, as well as quantized data (or quantized coefficients) 1512. The parser 1590 parses out the various syntax elements by using entropy-coding techniques such as context-adaptive binary arithmetic coding (CABAC) or Huffman encoding.

The inverse quantization module 1511 de-quantizes the quantized data (or quantized coefficients) 1512 to obtain transform coefficients, and the inverse transform module 1510 performs inverse transform on the transform coefficients 1516 to produce reconstructed residual signal 1519. The reconstructed residual signal 1519 is added with predicted pixel data 1513 from the intra-prediction module 1525 or the motion compensation module 1530 to produce decoded pixel data 1517. The decoded pixels data are filtered by the in-loop filter 1545 and stored in the decoded picture buffer 1550. In some embodiments, the decoded picture buffer 1550 is a storage external to the video decoder 1500. In some embodiments, the decoded picture buffer 1550 is a storage internal to the video decoder 1500.

The intra-prediction module 1525 receives intra-prediction data from bitstream 1595 and according to which, produces the predicted pixel data 1513 from the decoded pixel data 1517 stored in the decoded picture buffer 1550. In some embodiments, the decoded pixel data 1517 is also stored in a line buffer (not illustrated) for intra-picture prediction and spatial MV prediction.

In some embodiments, the content of the decoded picture buffer 1550 is used for display. A display device 1555 either retrieves the content of the decoded picture buffer 1550 for display directly, or retrieves the content of the decoded picture buffer to a display buffer. In some embodiments, the display device receives pixel values from the decoded picture buffer 1550 through a pixel transport.

The motion compensation module 1530 produces predicted pixel data 1513 from the decoded pixel data 1517 stored in the decoded picture buffer 1550 according to motion compensation MVs (MC MVs). These motion compensation MVs are decoded by adding the residual motion data received from the bitstream 1595 with predicted MVs received from the MV prediction module 1575.

The MV prediction module 1575 generates the predicted MVs based on reference MVs that were generated for decoding previous video frames, e.g., the motion compensation MVs that were used to perform motion compensation. The MV prediction module 1575 retrieves the reference MVs of previous video frames from the MV buffer 1565. The video decoder 1500 stores the motion compensation MVs generated for decoding the current video frame in the MV buffer 1565 as reference MVs for producing predicted MVs.

The in-loop filter 1545 performs filtering or smoothing operations on the decoded pixel data 1517 to reduce the artifacts of coding, particularly at boundaries of pixel blocks. In some embodiments, the filtering operation performed includes sample adaptive offset (SAO). In some embodiment, the filtering operations include adaptive loop filter (ALF).

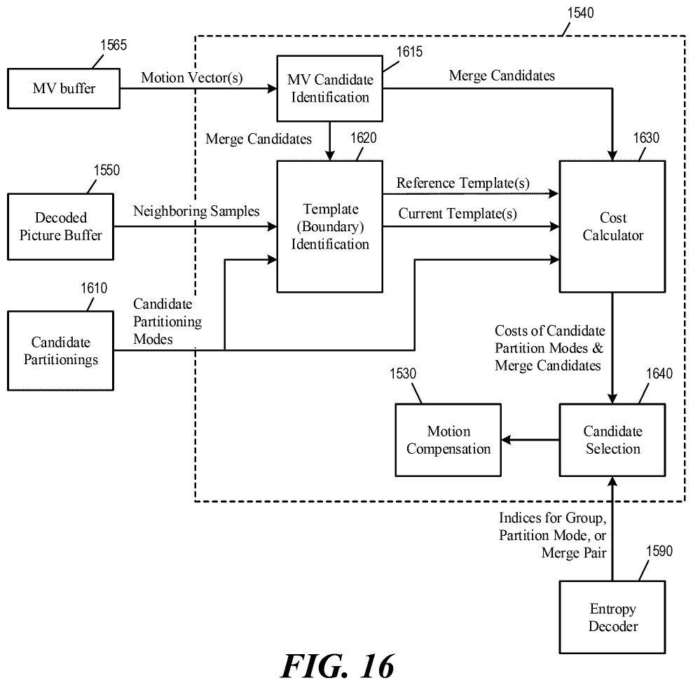

FIG. 16 illustrates portions of the video decoder 1500 that implement GPM predictor signaling based on TM or BM costs. Specifically, the figure illustrates the components of the inter-prediction module 1540 of the video decoder 1500. A candidate partitioning module 1610 provide candidate partition modes indicators to the inter-prediction module 1540. These possible candidate partition modes may correspond to various angle-distance pairings that defines a line that segments the current block into at least two (or more) partitions according to GPM. A MV candidate identification module 1615 identifies MV candidates (as merge candidates) that can be used for GPM partitions. The MV candidate identification module 1615 may identify only uni-prediction candidates or reuse merge prediction candidates from the MV buffer 1565.

For each merge candidates and/or for each candidate partition modes, a template or boundary identification module 1620 retrieves neighboring samples from the reconstructed picture buffer 1550 as L-shaped templates, or generates predicted samples along the boundary of the current block. For a candidate partition mode that partitions the current block into at least two partitions, the template identification module 1620 may retrieve neighboring pixels of the current block as two current templates and use two motion vectors to retrieve two L-shaped pixel sets as two reference templates for the at least two partitions of the current block.

The template identification module 1620 provides the reference template(s), the current template(s), and/or boundary prediction samples of the currently indicated coding mode to a cost calculator 1630, which performs template or boundary matching to produce a cost for the indicated candidate partition mode. The cost calculator 1630 may combine the reference templates (with edge blending) according to GPM mode. The cost calculator 1630 may also compute template or boundary matching costs for different merge candidate pairs of different candidate partition modes. The cost calculator 1640 may also assign reordered indices based on the computed costs to partition mode groups, partition modes within a group, and/or merge candidates of a partition formed by a partition mode. TM or BM cost-based indices reordering is described in Section I above.

The computed costs of the various candidates are provided to a candidate selection module 1640, which may use the computed TM or BM costs to select a lowest cost candidate partition mode or merge candidate pair for decoding the current block. The selected candidate partition mode or merge candidate pair may be indicated to the motion compensation module 1530 to complete prediction for decoding the current block. The candidate selection module 1640 may also receive a selection of a partition mode and/or merge candidate pair from the entropy decoder 1590. The signaling of the selection of the partition mode and/or merge candidate pair may be based on the reordered indices of the partition mode and/or merge candidate pair to reduce the number of bits transmitted. In some embodiments, the candidate partition modes are classified into groups, and the candidate selection module 1640 may receive an index indicating the group that includes the selected candidate partition mode from the entropy decoder 1590. In some embodiments, the partition mode and/or the merge candidate pair may be signaled implicitly (i.e., not in the bitstream) based on the computed costs at the decoder.

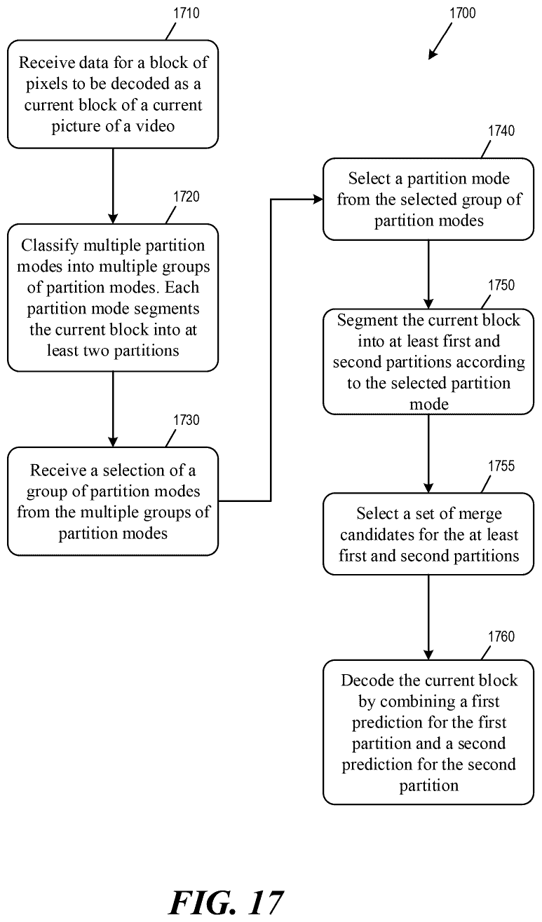

FIG. 17 conceptually illustrates a process 1700 for receiving selection of GPM partition modes. In some embodiments, one or more processing units (e.g., a processor) of a computing device implementing the decoder 1500 performs the process 1700 by executing instructions stored in a computer readable medium. In some embodiments, an electronic apparatus implementing the decoder 1500 performs the process 1700.

The decoder receives (at block 1710) data to be decoded as a current block of pixels in a current picture. The decoder classifies (at block 1720) a plurality of partition modes into a plurality of groups of partition modes. Each partition mode may be a GPM partition mode that segments the current block into at least two partitions.

The decoder receives (at block 1730) a selection of a group of partition modes from the plurality of groups of partition modes. This selection is based on the decoder computing a cost for decoding the current block for each partition mode of the plurality of partition modes, identifying a best partition mode from the plurality of partition modes based on the computed costs, and selecting a group of partition modes that includes the identified best partition mode. The decoder may identify the best partition mode by identifying a lowest cost partition mode for each group of the plurality of groups of partition modes. The cost for decoding the current block for a partition mode may be a template matching cost or a boundary matching cost of using the partition mode to decode the current block.

The decoder selects (at block 1740) a partition mode from the selected group of partition modes. The decoder may select the partition mode from the selected group by computing a cost for decoding the current block for each partition mode in the selected group of partition modes, then select a lowest cost partition mode from the selected group of partition modes. The decoder may also re-order the partition modes in the selected group according to the computed costs and receiving the selection of a partition mode based on the re-ordering.

The decoder segments (at block 1750) the current block into at least first and second partitions according to the selected partition mode.

The decoder selects (at block 1755) a set of at least two merge candidates for the first and second partitions. The merge candidate pair is used to generate a first prediction for the first partition and the second prediction for the second partition.

In some embodiments, the decoder selects the set of at least two merge candidates by computing a cost for each merge candidate of each of first and second partitions of the current block formed by the selected partition mode and selecting a set of at least two merge candidates for the first and second partitions based on the computed costs. The cost for a set of at least two merge candidates may be a template matching cost or a boundary matching cost of using the set of at least two merge candidates and the partition mode to code the current block.

In some embodiments, for each partition mode of the plurality of partition modes, the decoder computes a cost for each set of at least two merge candidates for the at least two partitions and identifies a best set of at least two merge candidates based on the computed costs of the set of at least two merge candidates. The selected partition mode has the lowest cost merge pair among the best pairs of merge candidates of the different partition modes.

The decoder decodes (at block 1760) the current block by combining a first prediction for the first partition and a second prediction for the second partition. The first and second predictions may be based on the selected set of at least two merge candidates. The decoder reconstructs the current block by using the first and second predictions and according to the selected partition mode.

### V. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

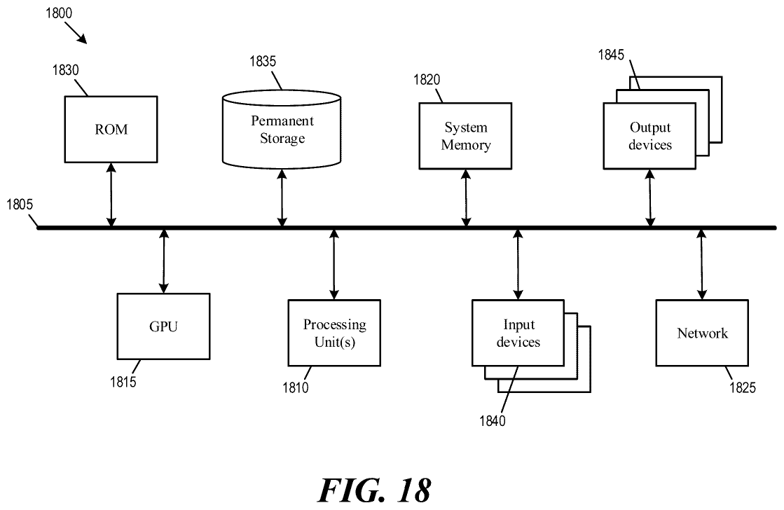

FIG. 18 conceptually illustrates an electronic system 1800 with which some embodiments of the present disclosure are implemented. The electronic system 1800 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1800 includes a bus 1805, processing unit(s) 1810, a graphics-processing unit (GPU) 1815, a system memory 1820, a network 1825, a read-only memory 1830, a permanent storage device 1835, input devices 1840, and output devices 1845.

The bus 1805 collectively represents all system, peripheral, and chipset buses that communicatively connect the numerous internal devices of the electronic system 1800. For instance, the bus 1805 communicatively connects the processing unit(s) 1810 with the GPU 1815, the read-only memory 1830, the system memory 1820, and the permanent storage device 1835.

From these various memory units, the processing unit(s) 1810 retrieves instructions to execute and data to process in order to execute the processes of the present disclosure. The processing unit(s) may be a single processor or a multi-core processor in different embodiments. Some instructions are passed to and executed by the GPU 1815. The GPU 1815 can offload various computations or complement the image processing provided by the processing unit(s) 1810.

The read-only-memory (ROM) 1830 stores static data and instructions that are used by the processing unit(s) 1810 and other modules of the electronic system. The permanent storage device 1835, on the other hand, is a read-and-write memory device. This device is a non-volatile memory unit that stores instructions and data even when the electronic system 1800 is off. Some embodiments of the present disclosure use a mass-storage device (such as a magnetic or optical disk and its corresponding disk drive) as the permanent storage device 1835.

Other embodiments use a removable storage device (such as a floppy disk, flash memory device, etc., and its corresponding disk drive) as the permanent storage device. Like the permanent storage device 1835, the system memory 1820 is a read-and-write memory device. However, unlike storage device 1835, the system memory 1820 is a volatile read-and-write memory, such a random access memory. The system memory 1820 stores some of the instructions and data that the processor uses at runtime. In some embodiments, processes in accordance with the present disclosure are stored in the system memory 1820, the permanent storage device 1835, and/or the read-only memory 1830. For example, the various memory units include instructions for processing multimedia clips in accordance with some embodiments. From these various memory units, the processing unit(s) 1810 retrieves instructions to execute and data to process in order to execute the processes of some embodiments.

The bus 1805 also connects to the input and output devices 1840 and 1845. The input devices 1840 enable the user to communicate information and select commands to the electronic system. The input devices 1840 include alphanumeric keyboards and pointing devices (also called “cursor control devices”), cameras (e.g., webcams), microphones or similar devices for receiving voice commands, etc. The output devices 1845 display images generated by the electronic system or otherwise output data. The output devices 1845 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 18, bus 1805 also couples electronic system 1800 to a network 1825 through a network adapter (not shown). In this manner, the computer can be a part of a network of computers (such as a local area network (“LAN”), a wide area network (“WAN”), or an Intranet, or a network of networks, such as the Internet. Any or all components of electronic system 1800 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 14 and FIG. 17) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data for a block of pixels to be encoded or decoded as a current block of a current picture of a video;
signaling or receiving a selection of a group of partition modes from a plurality of groups of partition modes, wherein the plurality of partition modes is classified into a plurality of groups of partition modes, each partition mode segmenting the current block into at least two partitions;
selecting a partition mode from the selected group of partition modes;
segmenting the current block into at least first and second partitions according to the selected partition mode; and
encoding or decoding the current block by combining a first prediction for the first partition and a second prediction for the second partition.

2. The video coding method of claim 1, further comprising:
computing a cost for encoding the current block for each partition mode of the plurality of partition modes;
identifying a best partition mode from the plurality of partition modes based on the computed costs; and
selecting a group of partition modes that includes the identified best partition mode.

3. The video coding method of claim 2, wherein the cost for encoding the current block for a partition mode is a template matching cost or a boundary matching cost of using the partition mode to encode the current block.

4. The video coding method of claim 2, wherein identifying the best partition mode comprises identifying a lowest cost partition mode for each group of the plurality of groups of partition modes.

5. The video coding method of claim 1, further comprising computing a cost for encoding the current block for each partition mode in the selected group of partition modes.

6. The video coding method of claim 5, wherein selecting a partition mode from the selected group of partition modes comprises selecting a lowest cost partition mode from the selected group of partition modes.

7. The video coding method of claim 5, wherein selecting a partition mode from the selected group of partition modes comprises re-ordering the partition modes in the selected group according to the computed costs and signaling or receiving a selection of a partition mode based on the re-ordering.

8. The video coding method of claim 1, further comprising:
computing a cost for each merge candidate of each of first and second partitions of the current block formed by the selected partition mode;
selecting a set of at least two merge candidates for the first and second partitions formed by the selected partition mode based on the computed costs;
wherein the first and second predictions are based on the selected set of at least two merge candidates.

9. The video coding method of claim 8, further comprising:
for each partition mode of the plurality of partition modes:
computing a cost for each set of at least two merge candidates for the at least two partitions formed by the partition mode; and
identifying a best set of at least two merge candidates for the at least two partitions based on the computed costs of the set of at least two merge candidates;
wherein the selected partition mode is selected based on the computed costs of the best set of at least two merge candidates of the plurality of partition modes.

10. The video coding method of claim 8, wherein the cost for a set of at least two merge candidates for the at least two partitions formed by the partition mode is a template matching cost or a boundary matching cost of using the set of at least two merge candidates and the partition mode to encode the current block.

11. A video coding method comprising:
receiving data for a block of pixels to be encoded or decoded as a current block of a current picture of a video;
signaling or receiving a selection of a partition mode from a plurality of partition modes, each partition mode segmenting the current block into at least two partitions;
computing a cost for each merge candidate of each of the at least two partitions of the current block formed by the selected partition mode;
selecting a set of at least two merge candidates for the at least two partitions formed by the selected partition mode based on the computed costs; and
encoding or decoding the current block by combining at least two predictions of the at least two partitions based on the selected set of at least two merge candidates.

12. The video coding method of claim 11, further comprising
for each partition mode of the plurality of partition modes:
computing a cost for each set of at least two merge candidates for the at least two partitions formed by the partition mode;
identifying a set of at least two merge candidates for the at least two partitions based on the computed costs;
wherein the selected partition mode is selected based on the computed costs of the identified pairs of merge candidates of the plurality of partition modes.

13. The video coding method of claim 11, wherein selecting the set of at least two merge candidates based on the computed costs comprises re-ordering the merge candidates of the at least two partitions formed by the selected partition mode according to the computed costs and signaling or receiving a selection of a set of at least two merge candidates based on the re-ordering.

14. The video coding method of claim 11, wherein selecting the set of at least two merge candidates based on the computed costs comprises selecting a set of at least two merge candidates having a lowest cost among the merge candidates of the at least two partitions formed by the selected partition mode.

15. An electronic apparatus comprising:
a video encoder or decoder circuit configured to perform operations comprising:
receiving data for a block of pixels to be encoded or decoded as a current block of a current picture of a video;
classifying a plurality of partition modes into a plurality of groups of partition modes, each partition mode segmenting the current block into at least two partitions;
signaling or receiving a selection of a group of partition modes from the plurality of groups of partition modes;
selecting a partition mode from the selected group of partition modes;
segmenting the current block into at least first and second partitions according to the selected partition mode; and
encoding or decoding the current block by combining a first prediction for the first partition and a second prediction for the second partition.

16. A video encoding method comprising:
receiving data for a block of pixels to be encoded as a current block of a current picture of a video;
classifying a plurality of partition modes into a plurality of groups of partition modes, each partition mode segmenting the current block into at least two partitions;
signaling a selection of a group of partition modes from the plurality of groups of partition modes;
selecting a partition mode from the selected group of partition modes;
segmenting the current block into at least first and second partitions according to the selected partition mode; and
encoding the current block by combining a first prediction for the first partition and a second prediction for the second partition.

17. A video decoding method comprising:
receiving data for a block of pixels to be decoded as a current block of a current picture of a video;
classifying a plurality of partition modes into a plurality of groups of partition modes, each partition mode segmenting the current block into at least two partitions;
receiving a selection of a group of partition modes from the plurality of groups of partition modes;
selecting a partition mode from the selected group of partition modes;
segmenting the current block into at least first and second partitions according to the selected partition mode; and
decoding the current block by combining a first prediction for the first partition and a second prediction for the second partition.
